(19) United States
(12) Patent Application Publication
(10) Pub. No.: US 2019/0269078 A1
(43) Pub. Date: Sep. 5, 2019

(54) Method and a system of using reservoirs to maintain root temperatures in a modularized aeroponics setup

(71) Applicant: Wanjun Gao, Weston, FL (US)

(72) Inventor: Wanjun Gao, Weston, FL (US)

(21) Appl. No.: 15/887,881

(22) Filed: Mar. 3, 2018

(51) Int. Cl. A01G 31/02

(52) U.S. Cl. CPC A01G 31/02; A01G 29/00

(57) ABSTRACT

The invention is a method and a system that use a distributed reservoir sub-system to maintain root temperatures in a modularized aeroponics setup. The reservoirs integrate with root chambers. Thermo-insulation materials and active temperature control functions are used to maintain temperatures of the nutrient reservoirs. Liquids in the reservoirs are further used as a media to maintain root chamber temperature and to reduce the fluctuations caused by pressurized nutrient delivery.

### BACKGROUND

Aeroponics is a process of growing plants in an air or mist environment without the use of soil or an aggregate medium (known as geoponics). A root chamber is a container where the roots are housed, and where the atomized nutrient droplets float before landing on roots.

In an aeroponics system, the desired temperatures in root chamber can reduce bacteria activities around root area, and can promote healthy transpiration. However, since the roots are suspended in the air, they are very susceptible to undesired ambient temperature and its fluctuations.

In practice, the temperature of indoor environment is often maintained purposefully to suit the growth of canopy, usually at a higher temperature level than the best suited for roots. The temperatures of outdoor environment are greatly affected by sunlight and other natural elements.

Unlike with other hydroponics methods, to control the temperature of aeroponics root chamber, cooling of delivered nutrient alone would not be sufficient, because
1, the amount of nutrient used with aeroponics method is small.
2, the sprays are intermittent and brief.

The impact of using the nutrients to maintain the temperature of the overall root chamber is limited. It can actually introduce undesired temperature fluctuation.

### BRIEF SUMMARY OF THE INVENTION

The invention is a method and a system of using reservoirs to maintain root temperatures in a modularized aeroponics setup. It is designed to minimize the impact of undesired and unstable ambient temperatures on roots in an aeroponics setup.

In this system, the root chambers and other components related to nutrient storage and delivery are thermo-insulated.

The root chambers are built with integrated nutrient reservoirs, in which the nutrient liquid serve as thermo capacitors for the root chambers.

Pressurized nutrient liquid to be sprayed into root chambers is contained and staged inside the reservoirs to reduce the temperature differences between them.

Active thermo-control and circulation functions are deployed to maintain the reservoir temperatures at desired levels.

A control unit is put in as part of the system to:
1, maintain the circulation of all the reservoirs in the system to keep reservoirs at a unified temperature;
2, monitor the temperature levels of the nutrients in the reservoirs; and
3, activate the thermo-control (cooling/warming) function accordingly to keep nutrients in reservoir at desired temperature level.

In short, this method and system use thermo-insulation materials and active temperature control functions to maintain temperatures of nutrient reservoirs; furthermore, they use the nutrient liquid in the reservoirs as media to maintain root chamber temperatures and to reduce the fluctuations caused by pressurized nutrient delivery.

There are no similar inventions to date.

### BRIEF DESCRIPTION OF THE DRAWINGS

FIG. 1 Thermo-controlled Modular Aeroponics System with Distributed Nutrient Reservoirs

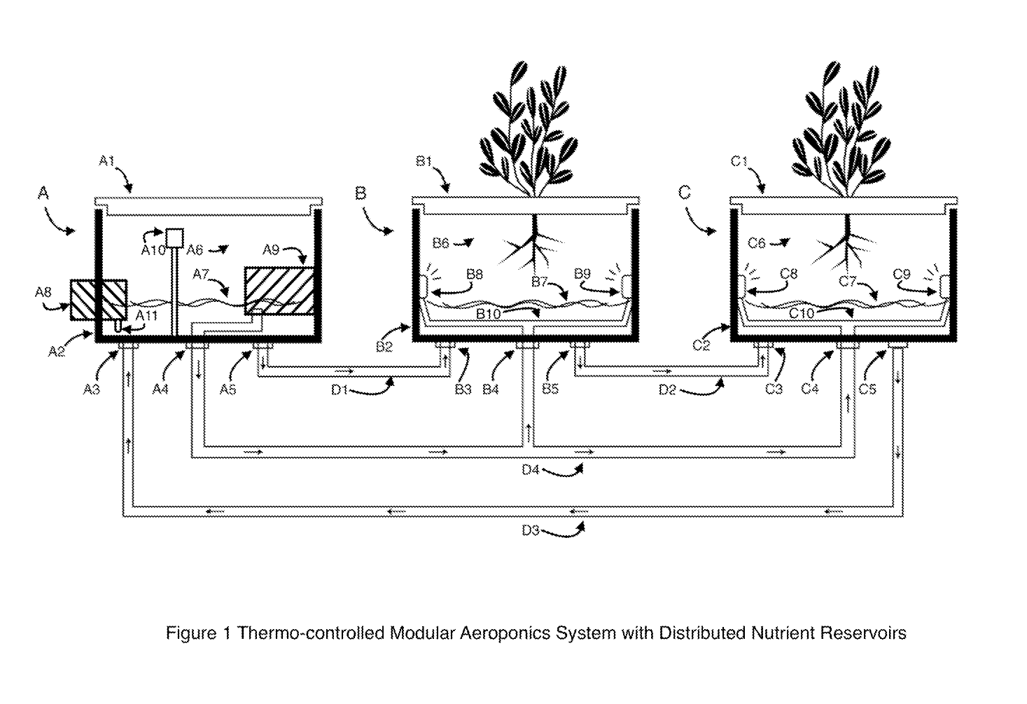

### DETAILED DESCRIPTION AND BEST MODE OF IMPLEMENTATION

The system consists of a control unit (A) and two grow units (B and C). The units' covers (A1, B1, C1) and bodies (A2, B2, C3) are made from thermo-insolated materials.

The integrated reservoir (A7) in the control unit and integrated reservoirs (B7, C7) in grow units serve the nutrient storage function.

For the pumping function, the outlet (A5) of the control unit (A) pushes nutrients from reservoir (A7) flowing through connecting tube (D1) to the inlet (B3) of a grow unit (B) and into its reservoir (B7), then through its outlet (B5) out of grow unit (B). The nutrients then flow through tube (D2) to the inlet (C3) of another grow unit (C) and into its reservoir (C7), then through its outlet (C5) out of grow unit (C). The nutrients then flow through a tube (D3) to the inlet (A3) of the control unit (A), and back in reservoir (A7) of the control unit (A). This forms a closed-loop Circulation Route.

The control unit (A) uses a pressurizing device (A9) to take nutrient liquid from its reservoir (A7) and pressurize the liquid and send atomized droplets through a connector

(A4) to a tube (D4), and through connectors (B4 and C4) of the grow units (B and C), before reaching staging areas (B10 and C10) where the nutrients are temperately stored until the sprayers (B8, B9, C8 and C9) open and deliver the nutrients into the root chambers (B6 and C6). The staging areas (B10 and C10) are contained by materials that allow heat exchange between the nutrients inside and outside of them to neutralize the temperature differences between the inside and the outside. These paths form open-looped nutrient Delivery Routes.

The control unit (A) uses a temperature sensor (A11) to monitor the temperature of nutrients in reservoir (A7), and deploys an active thermo control (A8) to cool down or warm up the temperature accordingly to achieve desired temperature level.

Optionally, the control unit (A) uses a level sensor (A10) to monitor nutrient level to ensure a proper nutrient level for nutrient circulation and delivery.

In the description above, the number of grow units can be one or multiple. The control unit and grow unit can also be integrated as one. The functions performed by the control unit can be separated into multiple physical devices.

Having described my invention, I claim:

1. A modular aeroponics system consists of one control unit and multiple grow units where plant roots grow.

2. Within the system in claim 1, the control unit contains one or more nutrient reservoirs. Each grow unit's lower space of root chamber also serves as a nutrient reservoir. There is one inlet and one outlet for each reservoir, whether it is located within the control unit or within a grow unit.

3. A system in claim 1 contains two nutrient flow routes: Delivery Route and Circulation Route.

4. Within the system in claim 1, the control unit delivers pressurized nutrients to each grow unit through the Delivery Route. The grow units form small nutrient droplets and deliver them to the plant roots.

5. Within the system in claim 1, the nutrient reservoirs of the control unit and the reservoirs of the grow units are inter-connected and cycled throughout the Circulation Route.

6. Within the system in claim 1, the nutrient related components form a nutrient sub-system. The nutrient sub-system is fully or partially thermo-insulated. The nutrient sub-system includes, but is not limited to, the reservoirs in the control unit, the root chambers of the grow units, and the nutrient Delivery/Circulation tubes that connecting units.

7. Within the system in claim 1, the nutrient Circulation Route forms a serial closed-loop path, so that the nutrient flows from the control unit's outlet, serially passes though each grow unit's inlet, reservoir and outlet, and finally returns back to the control unit via its inlet.

8. Within the system in claim 1, circulation via the Circulation Route may be powered by one or more pumps; the pump(s) may be inside the control unit or may be any where on the Circulation Route path.

9. Within the system in claim 1, circulation inside of the grow unit reservoir can be achieved by properly positioning its inlet and outlet, or by utilizing assisting mechanism such as pump(s).

10. Within the system in claim 1, the control unit monitors the circulated nutrient temperature and activates thermo-control (cooling/warming) function accordingly.

11. In the grow units of the system in claim 1, a portion of Delivery Route tubes are submerged in the reservoir within the root chamber to form a staging area before nutrient liquid is sprayed. The submerged tubes can be containers in various shapes. Optional heat exchange mechanisms can be used to facilitate the process in order to neutralize the temperature differences between liquid inside and outside of the staging area.

12. Within the system in claim 1, the control unit may be in the form of one physical device or multiple physical devices. The functions of the control unit may be separated into and performed by multiple physical devices.
